(19) United States
(12) Patent Application Publication
(10) Pub. No.: US 2010/0251110 A1
(43) Pub. Date: Sep. 30, 2010

(54) DOCUMENT PROCESSING APPARATUS, CONTROL METHOD THEREFOR, AND COMPUTER-READABLE STORAGE MEDIUM STORING PROGRAM FOR THE CONTROL METHOD

(75) Inventor: Shigeyuki Mitani, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/730,570

(22) Filed: Mar. 24, 2010

(30) Foreign Application Priority Data
Mar. 30, 2009 (JP) 2009-082080

(51) Int. Cl. G06F 17/00

(52) U.S. Cl. 715/273

(57) ABSTRACT

When editing a document having a page that contains image data and text data arranged to coexist, a document processing apparatus determines whether text data exists in each text region in the page. Then, when a user inputs a predetermined operation, among a plurality of text regions in the page, the document processing apparatus performs, on a screen thereof, enlargement display of ranges respectively containing text regions each of which is determined so that text data exists therein. Consequently, when editing a document having a page that contains image data and text data arranged to coexist, users can easily confirm input contents of text.

### BACKGROUND OF THE INVENTION

1. Field of the Invention

The present invention relates to a document processing apparatus for processing a document in which images and character strings are laid out, a control method therefor, a program for performing the control method, and a storage medium for computer-readably storing the program.

2. Description of the Related Art

Hitherto, documents have been edited by laying out images and character strings in each page. When users manually input character strings using keyboards, erroneous inputs may frequently occur. When many character strings and images coexist and are laid out in many pages, it is difficult for users to confirm input contents of the character strings. There have been demands for correcting character strings laid out in the above manner by confirming the input contents of the character strings while recognizing a state of layout of a portion around the character strings, e.g., a positional relationship between an image and each of the character strings.

### SUMMARY OF THE INVENTION

The present invention is directed to a document processing apparatus for enabling a user to easily confirm, when a document is edited by laying out images and character strings, not only input contents of character strings but a layout of a portion around the character strings.

According to an aspect of the present invention, a document processing apparatus for displaying, on a screen, a page containing image data and text data arranged to coexist. The page has a text region into which the text data is inserted. The document processing apparatus includes a determination unit configured to determine whether the text data exists in the text region, and a display unit configured to, in response to a predetermined operation, enlarge and display, on the screen, a range containing the text region in the page if it is determined by the determination unit that the text data exists in the text region.

According to an exemplary embodiment of the present invention, when a document is edited by laying out an image and a character string in a page, a user can easily confirm not only the input contents of the character string but a layout of a portion around the character string.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a configuration of a document editing apparatus according to an exemplary embodiment of the present invention.

FIG. 2 is a diagram illustrating an example of a layout confirmation window according to an exemplary embodiment of the present invention.

FIGS. 3A through 3D are diagrams illustrating an example of a data structure according to an exemplary embodiment of the present invention.

FIGS. 4A through 4C are diagrams illustrating an example of the layout confirmation window according to an exemplary embodiment of the present invention.

FIG. 5 is a flowchart illustrating an example of an operation to be performed by the document editing apparatus in a layout confirmation mode according to an exemplary embodiment of the present invention.

FIG. 6 is a flowchart illustrating an example of an operation to be performed by the document editing apparatus in a text confirmation mode according to an exemplary embodiment of the present invention.

FIG. 7 is a diagram illustrating an example of a text editing window according to an exemplary embodiment of the present invention.

FIG. 8 is a diagram illustrating an example of a page display region of a layout confirmation window according to an exemplary embodiment of the present invention.

FIGS. 9A and 9B are diagrams illustrating an example of the layout confirmation window according to an exemplary embodiment of the present invention.

FIG. 10 is a flowchart illustrating an example of an operation to be performed by an information processing apparatus when print data is generated according to an exemplary embodiment of the present invention.

FIG. 11 is a diagram illustrating an example of an alarm panel according to an exemplary embodiment of the present invention.

FIGS. 12A and 12B are diagrams illustrating an example of a layout confirmation window according to an exemplary embodiment of the present invention.

### DESCRIPTION OF THE EMBODIMENTS

Various exemplary embodiments, features, and aspects of the invention will be described in detail below with reference to the drawings.

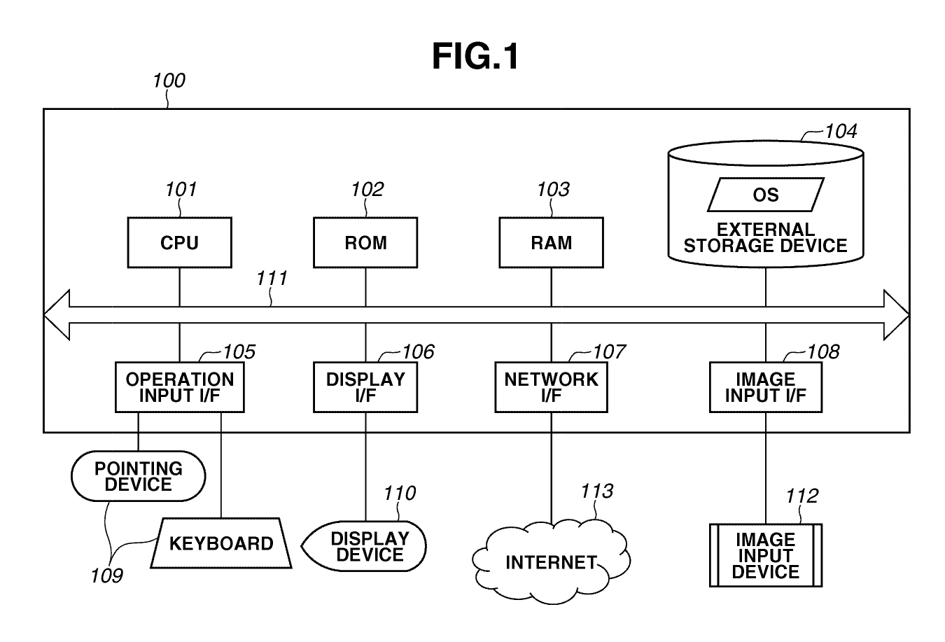

A document editing apparatus according to an embodiment of the present invention is implemented by an information processing apparatus such as a personal computer apparatus. A configuration of the document editing apparatus is described hereinafter with reference to a block diagram illustrated in FIG. 1. The document editing apparatus 100 can be implemented by a single apparatus. Alternatively, the document editing apparatus 100 can be implemented by distributing functions of the document editing apparatus 100 to a plurality of apparatuses according to needs. When the document editing apparatus 100 includes a plurality of apparatuses, the plurality of apparatuses are connected by, e.g., a local area network (LAN) so as to be able to communicate with one another. Referring to FIG. 1, a control unit 101 controls the entire document editing apparatus 100 and is, e.g., a central processing unit (CPU). A read-only memory (ROM) 102 stores programs and parameters, which do not need to be changed. A random access memory (RAM) 103 temporarily stores programs and data supplied from, e.g., an external apparatus. An external storage device 104 includes a hard disk and a memory card fixedly placed in the document editing apparatus 100, or a floppy disk (FD), an optical disc such as a compact disc (CD), a magnetic card, an optical card, and an integrated circuit (IC) card removably mounted in the document editing apparatus 100. The external storage device 104 stores software programs such as an operating system (OS) and a document editing application program, and various files such as an image file. An operation input interface (IF) 105 is connected to input devices 109 such as a pointing device and a keyboard for inputting data in response to a user's operation. A display IF 106 is connected to a display device 110 for displaying data stored by the document editing apparatus 100 and externally supplied data. A network IF 107 is connected to a network line such as the Internet 113. An image input IF 108 is connected to an image input device 112 such as a camera and a scanner. A system bus 111 connects modules 101 though 108 to one another so as to be able to communicate with one another.

First, the control unit 101 of the document editing apparatus 100 reads an OS and a document editing application program from the external storage device 104. According to the read OS and the read document editing application program, the document editing apparatus 100 implements the following operation by controlling the above modules. First, the control unit 101 activates the document application program and displays a document editing window on the screen of the display device 110. Then, in response to a user's operation, the control unit 101 reads image files from the external storage device 104 and selects some of the read image files. The control unit 101 generates document data by laying out the selected image files in a plurality of pages and displays resultant document data on the document editing window. In addition, the control unit 101 lays out character strings input in each page in response to a user's operation. The control unit 101 performs layout editing operations, such as trimming (cropping) and rotation operations, an operation of interchanging with another image, and a deletion operation on images displayed on the document editing window and correction and deletion operations on character strings displayed thereon.

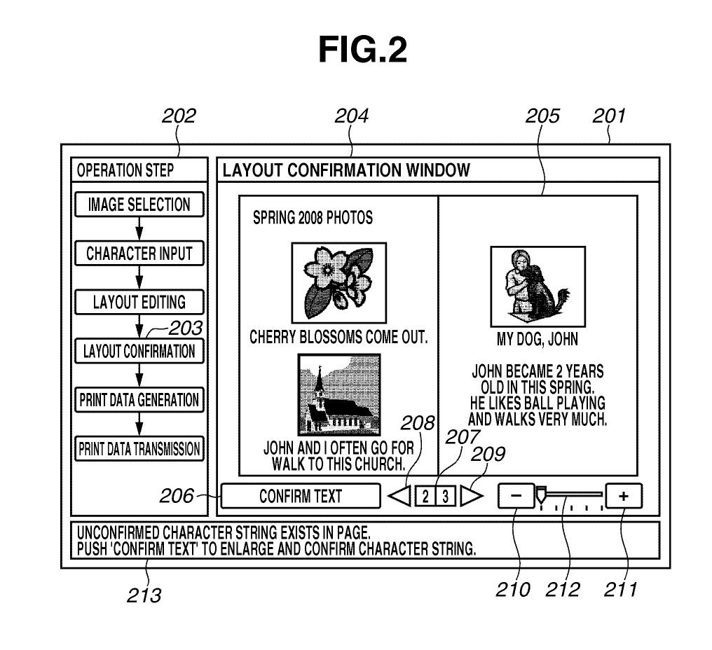

When receiving a layout confirmation instruction in response to a user's operation after performing image selection, character input, and layout editing operations, the control unit 101 displays a document editing window 201 as illustrated in FIG. 2. A list of steps of a “document generation process” is displayed on an operation step area 202 so that a currently performed step can be distinguished from other steps. A user can instruct to change the currently step to another step by selecting a given step. As is seen from FIG. 2, the “document generation process” includes an “image selection” step, a “character input” step, a “layout editing” step, a “layout confirmation” step, a “print data generation” step, and a “print data transmission” step. FIG. 2 indicates that the currently performed step is the “layout confirmation” step 203. A layout confirmation window 204 is displayed in the “layout confirmation” step 203. Two facing-pages of a document are displayed in a page display region 205. A text confirmation button 206 can be used by a user to instruct to start confirmation of a character string region arranged in the pages. Referring to FIG. 2, the text confirmation button 206 is in a selectable state. The expression “CONFIRM TEXT” indicating an instruction to start a text confirmation process is set and displayed on a label of the text confirmation button 206. A page number 207 is displayed in the page display region 205. Page turning buttons 208 and 209 are used to instruct to change a page to be displayed in the page display region 205. The page turning button 208 is used to change a current page to another page whose page number is smaller than that of the current page. The page turning button 209 is used to change the current page to another page whose page number is larger than that of the current page. A page to be displayed in the page display region 205 can also be designated by directly inputting a page number into a page number column 207. Operation units 210, 211, and 212 are used to instruct to change a display magnification in the page display region 205. A reducing button 210 is used to instruct to reduce the display magnification at a constant rate. An enlarging button 211 is used to instruct to increase the display magnification at a constant rate. A slider 212 is used to present a current display magnification and to change the current display magnification to a desired display magnification. A user uses input devices, such as a pointing device 109 and a keyboard 109, to operate control elements 207, 208, and 209 for changing a page to be displayed, and control elements 210, 211, and 212 for changing a display magnification. Alarm messages and operation guide messages are displayed in a message area 213 and notified to users.

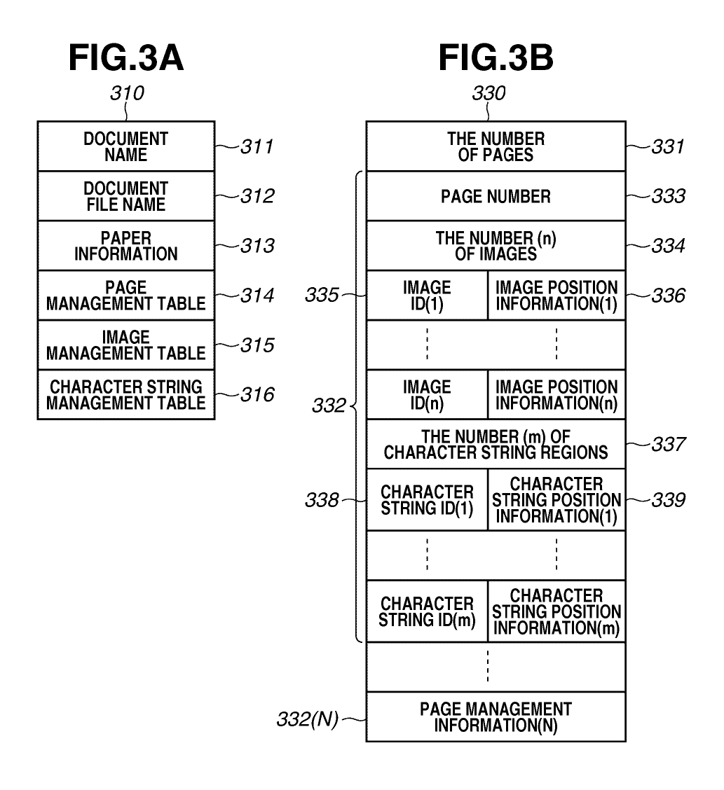

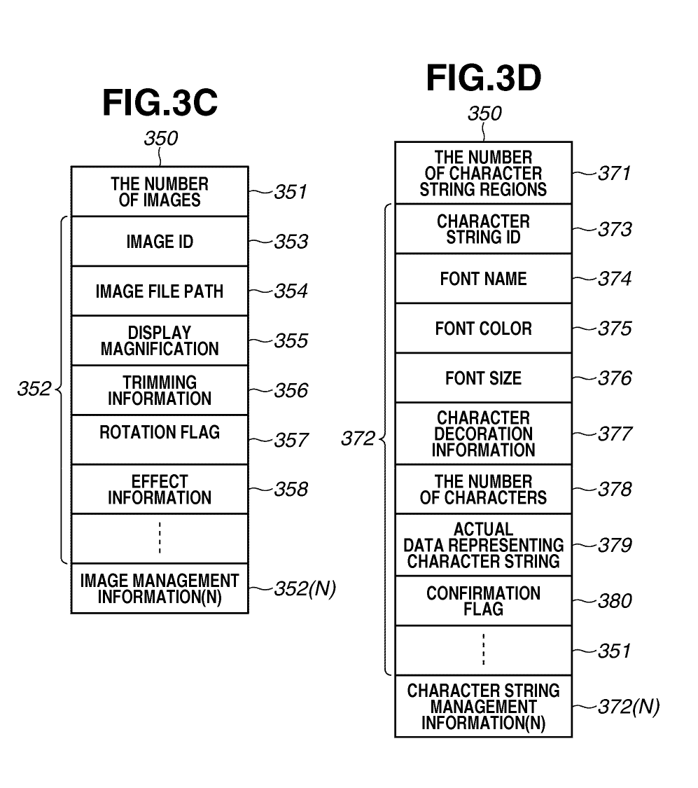

Hereinafter, a data structure of a document generated in the above manner is described with reference to FIGS. 3A through 3D. FIG. 3A illustrates a document management table 310 that stores data for managing the entire document. A data storage area 311 stores a document name that is a given character string used to identify a document. A data storage area 312 stores information representing a file path of a file for storing the document management table 310. An information storage area 313 stores paper information representing a size, a shape, and quality of paper, a book-binding method and a finishing method to be used when print processing is performed according to document data. A data storage area 314, a data storage area 315, and a data storage area 316 store data pointers or actual data of the page management table, the image management table, and the character string management table, respectively. FIG. 3B illustrates the data structure of the page management table 330, which stores data for managing a plurality of pages contained in a document. A data storage area 331 stores data representing a total number of pages contained in a document. Information storage areas 332 store page management information concerning each page. There are the information storage areas 332 the number of which is equal to that of pages contained in a document. A data storage area 333 stores data representing the page number of each page. A data storage area 334 stores data representing the number of images, more specifically, a total number of image files laid-out in the associated page. An information storage area 335 stores identification information (image ID) for identifying an image on the associated page, which is given to the image according to a position of the image when the image is laid out on the page. According to the present embodiment, serial integer numbers are respectively given to images arranged from top left to bottom right of the associated page in an arrangement order. An information storage area 336 stores image position information representing coordinates of image files laid out on the associated page. According to the present embodiment, the coordinates corresponding to a top left position and a bottom right position of images laid out by setting the top left position of the associated page as an origin. The image position information 336 is stored by being associated with the image ID 335. There are combinations of the image position information and the image ID, the number of which is equal to that of images laid out on the associated page. A data storage area 337 stores data representing the number of character string regions, more specifically, a total number of character string regions laid out on the associated page. An information storage area 338 stores identification information, more specifically, character string ID for identifying a character string region on the associated page, which is given to the character string region laid out on the associated page according to the position of the character string region. According to the present embodiment, serial integer numbers are respectively given to character string regions arranged from top left to bottom eight in an arrangement order. An information storage area 339 stores character string position information representing coordinates of positions of character string regions laid on the associated page. According to the present embodiment, the information storage area 339 stores character string position information, more specifically, coordinates corresponding to a top left position and a bottom right position of character string regions laid out by setting the top left position of the associated page as an origin. The character string position information 339 is stored by being associated with the character string ID 338. There are combinations of the character string position information and the character string ID, the number of which is equal to that of character strings laid out on the associated page. FIG. 3C illustrates the data structure of the image management table 350, which is used to manage data concerning images contained in a document. A data storage area 351 stores data representing the number of images, more specifically, a total number of image files contained in a document. Information storage areas 352 store image management information concerning each image. There are the information storage areas 352 the number of which is equal to that of image files contained in a document. A data storage area 353 stores an image ID. An information storage area 354 stores information representing an image file path, more specifically, information representing a location at which image files are stored in the external storage device 104. A data storage area 355 stores a display magnification, more specifically, a scale at which an image is displayed in the page display region. An information storage area 356 stores trimming information, more specifically, information representing coordinates of a trimming region when an image is displayed in the page display region by being trimmed. A data storage area 357 stores a rotation flag, more specifically, data representing a direction of rotation and an angle of rotation when an image is displayed in the page display region. An information storage area 358 stores effect information, more specifically, information representing effects (adjustment of luminosity, saturation, and hue, gradation, and red-eye correction) on an image when the image is displayed in the page display region. FIG. 3D illustrates the data structure of the character string management table 370, which is used to manage character strings contained in a document. A data storage area 371 stores data representing the number of character string regions, more specifically, a total number of character string regions. Information storage areas 372 store character string management information, more specifically, information concerning a character string to be input to each character string region. There are information storage areas 372 the number of which is equal to that of character strings contained in a document. A data storage area 373 stores a character string ID. A data storage area 374 stores data representing a font name of a font of a character string. A data storage area 375 stores data representing a font color of a font of a character string. A data storage area 376 stores data representing a font size of a font of a character string. An information storage area 377 stores character decoration information concerning character-alignment, italicization, underlining, and the like. A data storage area 378 stores data representing the number of characters. The number of characters of the character string set in a character string region is recorded therein. When no character string is input in the character string region, the number of characters of the character string is “0”. A data storage area 379 stores actual data representing a character string, more specifically, actual data representing a character string input to a character string region. An information storage area 380 stores information representing a confirmation flag. Information representing whether enlargement display of the character string region is performed in a text confirmation mode is recorded therein.

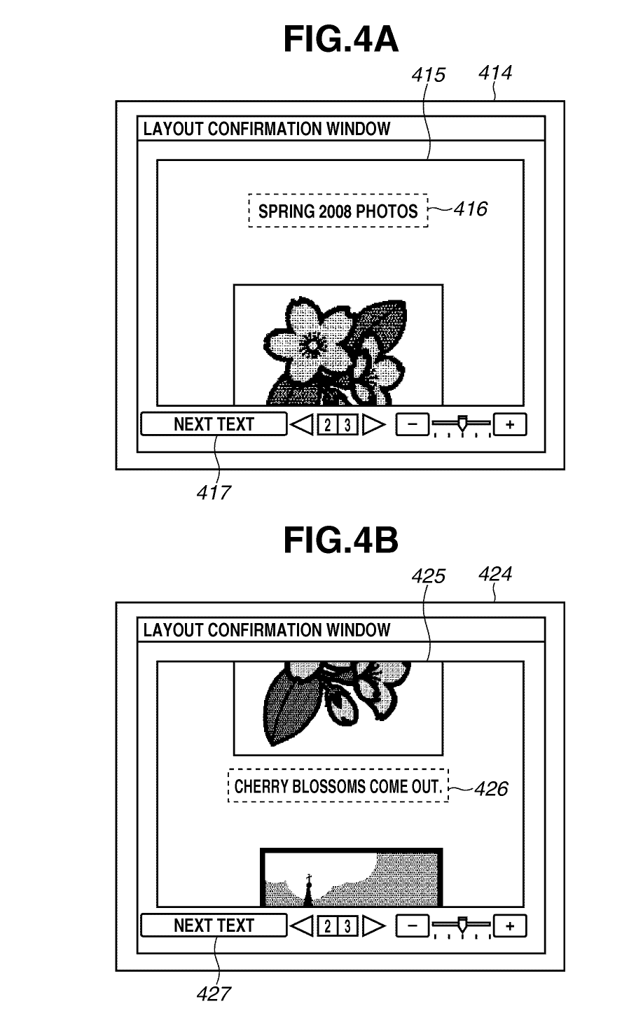

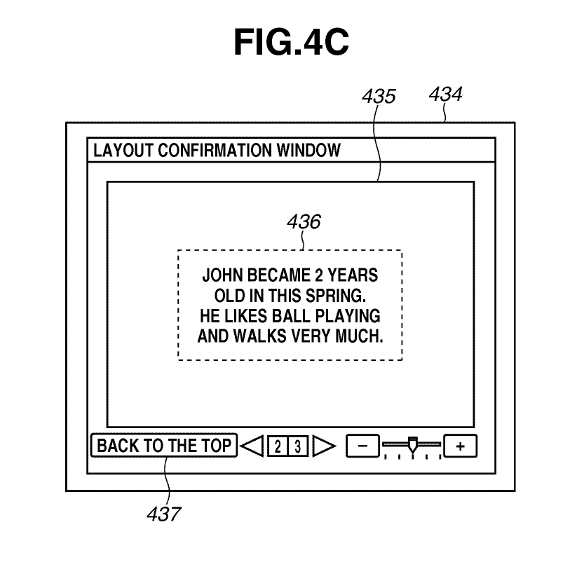

Next, the control unit 101 detects that the text confirmation button 206 is pressed in response to a user's operation. Contents displayed on the layout confirmation window when performing the text confirmation mode are described hereinafter with reference to FIGS. 4A through 4C. When the text confirmation button 206 is pressed in response to a user's operation and a text confirmation process is started in a state in which the layout confirmation window illustrated in FIG. 2 is displayed, the display of this layout confirmation window is changed to that of a layout confirmation window 414 illustrated in FIG. 4A. In a page display region 415, a portion around a character string region 416, which is located at the leftmost top of page 2 and has a character string ID of “1”, is enlarged and displayed. The expression “NEXT TEXT” indicating the transition of a current string region to the next character string region is displayed on the label of a text confirmation button 417. When the text confirmation button 417 is pressed in response to a user's operation, the current display of the layout confirmation window 414 is changed to that of a layout confirmation window 424. In a page display region 425, a portion around a character string region 426, which is the second character string region from the top in page 2 and has a character string ID of “2”, is enlarged and displayed. The expression “NEXT TEXT” indicating the transition of the current character string region to the next character string region is displayed on the label of a text confirmation button 427. When a character string region to currently be confirmed reaches the last character string region on the facing-pages as a result of iteratively pressing the text confirmation button in response to user's operations, the current layout confirmation window is changed to a layout confirmation window 434 illustrated in FIG. 4C. In a page display region 435, a portion around a character string region 436, which is located at the bottom on page 3 and which has a character string ID of “2”, is enlarged and displayed. When the text confirmation process is continued, the expression “BACK TO THE TOP” is displayed on the label of a text confirmation button 437.

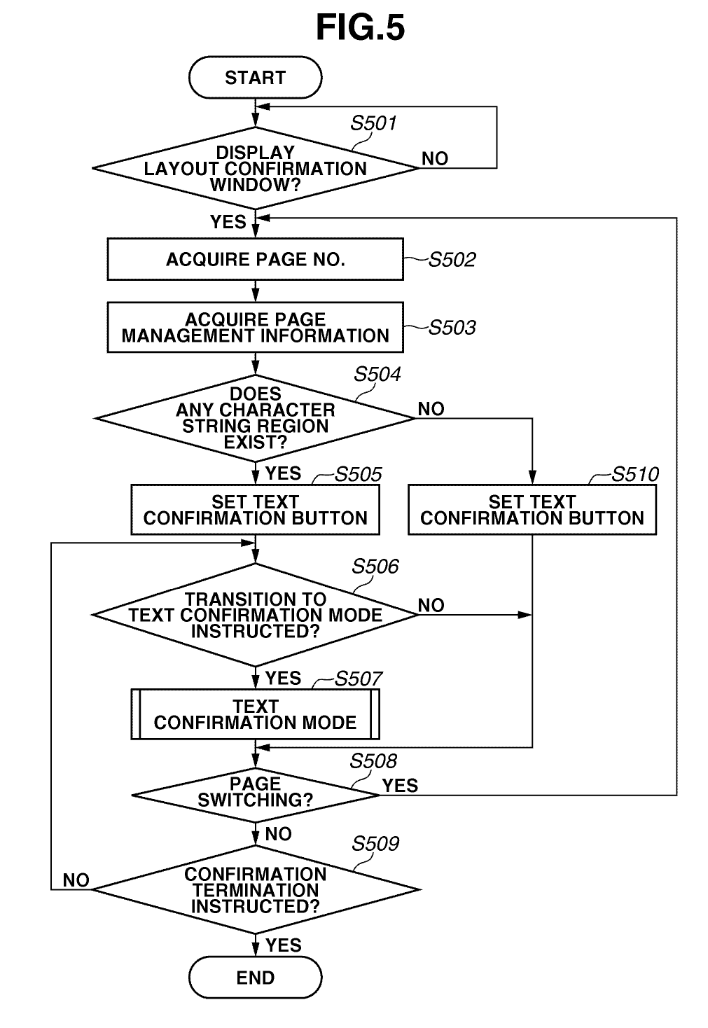

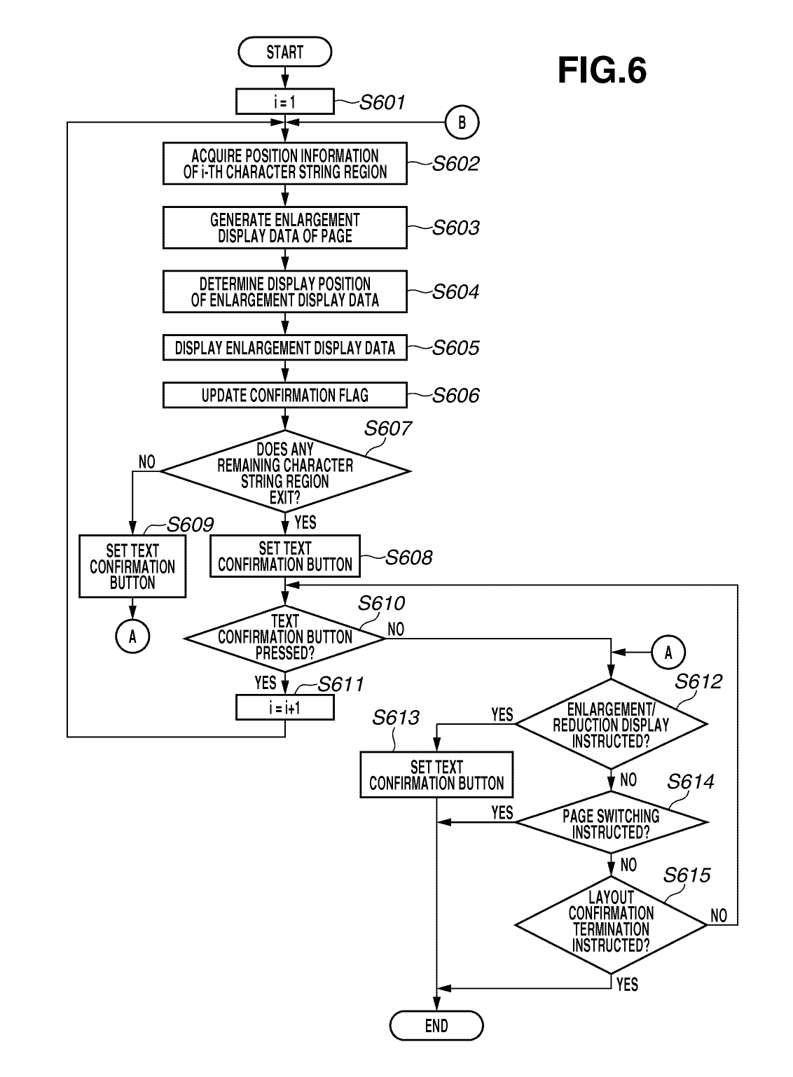

Next, an operation performed by the control unit 101 in the text confirmation mode is described hereinafter with reference to FIGS. 5 and 6. The following operation is performed by the control unit 101 of the document editing apparatus 100, which controls various modules according to the OS and the document editing application program, which are stored in the external storage device 104 or the like.

First, in step S501, the control unit 101 determines whether to display the layout confirmation window 204. When the layout confirmation 203 is instructed in response to a user's operation, the control unit 101 determines to display the layout confirmation window 204. Then, if it is determined to display the layout confirmation window 204 (YES in step S501), then in step S502, the control unit 101 acquires the page number of a page to be displayed in the page display region 205. The acquired page number is that of a leading page (i.e., a front-cover page (or page 0)), a first page, a page to be edited in a preceding layout editing process, a user's optionally designated page, or the like. In step S503, the control unit 101 acquires page management information 332 corresponding to the page number acquired in step S501. In step S504, the control unit 101 determines, based on the number of the character string regions 337 in the storage area that stores the page management information 332, whether a character string region exists in the associated page. If it is determined that no character string exists (NO in step S504), then in step S510, the control unit 101 sets the layout confirmation window 204 by bringing the text confirmation button into an unselectable state. Thus, this operation is finished. On the other hand, if it is determined that a character string exists (YES in step S504), then in step S505, the control unit 101 puts the text confirmation button 206 into a selectable state with the expression “CONFIRM TEXT” on the label and sets the layout confirmation window 204. In step S506, the control unit 101 determines whether an instruction to transition of the current mode to the text confirmation mode is issued. If the text confirmation button 206 is pressed in response to a user's operation, it is determined that an instruction to perform the transition of the current mode to the text confirmation mode is issued. If it is determined that an instruction to perform the transition of the current mode to the text confirmation mode is issued (YES in step S506), then in step S507, the control unit 101 performs a text confirmation mode process, which will be described below. Then, in step S508, the control unit 101 determines whether a page turning instruction is issued. If the page turning button 208 or 209 is pressed in response to a user's operation, or if a page number indicated by the page number column 207 is changed, the control unit 101 determines that a page turning instruction is issued. If it is determined that a page turning instruction is issued (YES in step S508), the control unit 101 returns to step S502. If it is determined that a page turning instruction is not issued (NO in step S508), then in step S509, the control unit 101 determines whether an instruction to finish layout confirmation is issued. If a process other than the “layout confirmation” step 203 is designated, the control unit 101 determines that the instruction to finish the layout confirmation is issued. If it is determined that the instruction to finish the layout confirmation is issued (YES in step S509), the control unit 101 finishes this operation. If it is determined that the instruction to finish the layout confirmation is not issued (NO in step S509), the control unit 101 returns to step S506.

Next, an operation performed by the control unit 101 in the text confirmation mode in step S507 is described hereinafter with reference to FIG. 6. First, in step S601, the control unit 101 initializes a variable “i” for counting the character string ID of the character string region, so that “i”=1. In step S602, the control unit 101 acquires character string position information 339 corresponding to the i-th character string ID 338 stored in the storage area “page management information” 332. In step S603, the control unit 101 generates data for enlargement display of a page according to a predetermined magnification. In step S604, the control unit 101 determines a position of the character string so that a part including a region represented by coordinates of the character string position information 339 is displayed in the page display region 205. In step S605, the control unit 101 displays the position determined in step S604 in the page display region 205 among those represented by the data for enlargement display, which is generated in step S603. Consequently, the enlargement display of the character string region and a portion therearound is performed. Thus, a user can easily confirm input contents of the character string region and the layout of a portion therearound. In step S606, the control unit 101 updates the confirmation flag 380 corresponding to the character string ID 338 (or 373) into a confirmed state.

Next, in step S607, the control unit 101 determines whether any remaining character string region exists. If it is determined that no remaining character string region exists (NO in step S607), then in step S609, the control unit 101 brings the text confirmation button 206 into a unselectable state, and sets the text confirmation button 206 in the layout confirmation window 204. Then, the control unit 101 substitutes “0” for the variable “i” and then proceeds to step S612. On the other hand, if it is determined that a remaining character string region exists (YES in step S607), then in step S608, the control unit 101 puts the text confirmation button 206 into a selectable state, and sets the expression “NEXT TEXT” on the label for prompting the transition to the next character string region, and also sets the text confirmation button 206 in the layout confirmation region 204. In step S610, the control unit 101 determines whether the text confirmation button 206 is pressed. If it is determined that the text confirmation button 206 is pressed (YES in step S610), then in step S611, the control unit 101 adds 1 to the variable “i” and then performs transition to step S602. If it is determined that the text confirmation button 206 is not pressed (NO in step S610), then in step S612, the control unit 101 determines whether enlargement/reduction display is instructed. If the reducing button 210 or the enlarging button 211 is pressed, or if the slider 212 is moved, the control unit 101 determines that enlargement/reduction display is instructed. If it is determined that enlargement/reduction is instructed (YES in step S612), the control unit 101 returns to an ordinary mode in which the apparatus is brought before the transition of the apparatus to the text confirmation mode is performed. In step S613, the control unit 101 sets the text confirmation button 206 so that the label thereof is put back to the expression “CONFIRM TEXT”. Then, the control unit 101 generates a page display image corresponding to the designated magnification and displays a predetermined position in the page display region 205. If it is determined that enlargement/reduction display is not instructed (NO in step S612), then in step S614, the control unit 101 determines whether a page turning instruction is issued. If it is determined that no page turning instruction is issued (NO in step S614), then in step S615, the control unit 101 determines that an instruction to finish the layout confirmation is issued. If the control unit 101 determines that no instruction to finish the layout confirmation is issued (NO in step S615), the control unit 101 returns to step S610. If the control unit 101 determines that a page turning instruction is issued (YES in step S614), or if it is determined that an instruction to finish the layout confirmation is issued (YES in step S615), the control unit 101 finishes this operation.

Thus, portions around character string regions are sequentially enlarged and displayed. Consequently, a user can confirm without omission whether there is a non-input character string region or an erroneous input character string region.

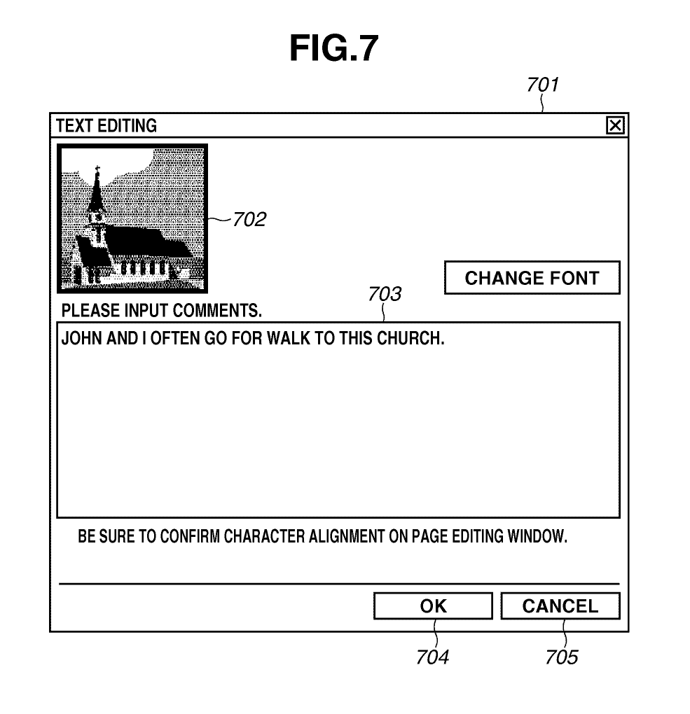

If the control unit 101 selects a character string region displayed in the page display region 205 or a correction instruction in response to a user's operation in an ordinary mode or a page confirmation mode, the control unit 101 displays a text editing window 701 as illustrated in FIG. 7. A thumbnail image 702 corresponds to an image with which a text string region to be corrected is associated. A given character string input by a user using a keyboard or the like is displayed in a text entry field 703. When the control unit 101 detects that an “OK” button 704 is pressed, the control unit 101 stores the character string displayed in the text entry field 703 as actual data 379 representing the character string in the corresponding character string region. A “CANCEL” button 705 is used to instruct cancellation of input of a character string.

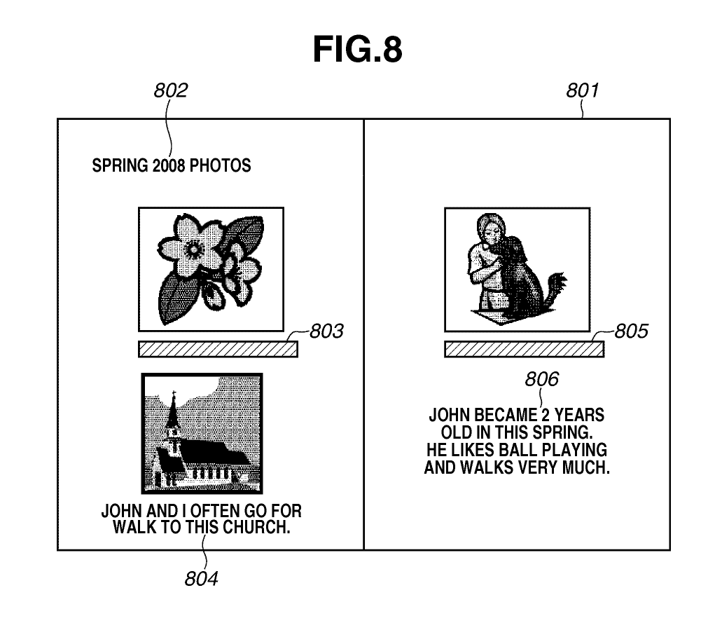

In the foregoing description, it has been described that enlargement display can be performed on all character string regions by the control unit 101. However, the apparatus can be modified so that the control unit 101 does not perform enlargement display on a character string region in which no character string is input, and that the control unit 101 can perform enlargement display only on character string regions in each of which a character string is input. At that time, if the control unit 101 detects that the text confirmation button 206 is pressed, the control unit 101 refers to data representing the number of characters 378 in each character string region and performs enlargement display of character string regions the number of characters in each of which is larger than 0. That is, when no character strings are input to character string regions 803 and 805 as illustrated in FIG. 8, the control unit 101 performs enlargement display on portions around character string regions 802, 804, and 806 sequentially, whereas the control unit 101 does not perform enlargement display on the character string regions 803 and 805. Consequently, the control unit 101 sequentially performs enlargement display only on character string regions in each of which a character string region may erroneously be input. Accordingly, a confirmation operation can quickly be performed. Thus, a user can save a trouble of confirming character string regions into each of which the user intentionally input no character strings.

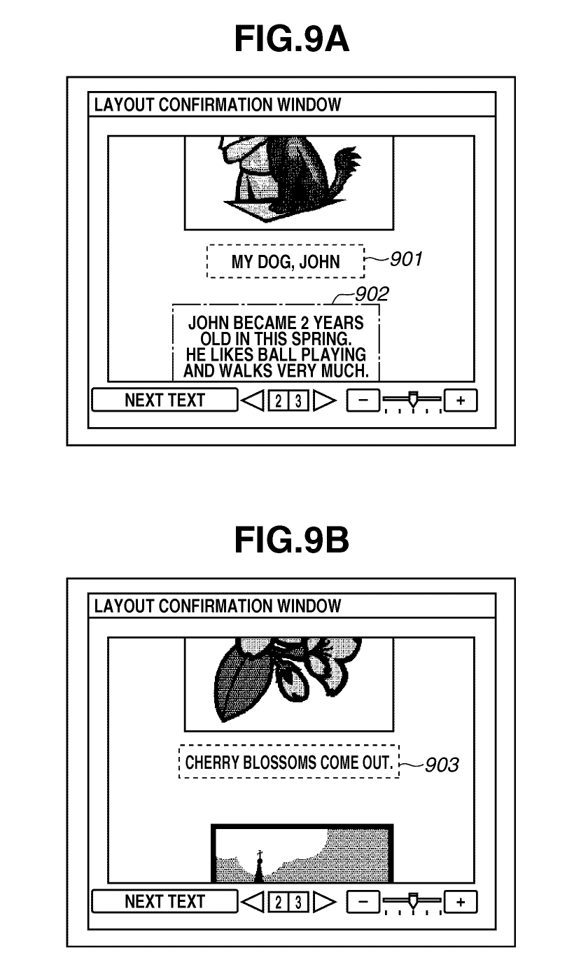

When the control unit 101 performs enlargement display on a character string region in the text confirmation mode, in a case where a plurality of character string regions are included in a page display region, the control unit 101 can provide a display so that a character string region to currently be confirmed is distinguished from other character string regions. It can be considered that a character string region 901 to currently be confirmed is displayed by being surrounded with lines, the type and the color of which are changed from those of lines surrounding other character string regions 902, as illustrated in FIG. 9A, or that a mark is displayed in the vicinity of the character string region 901 to currently be confirmed. Consequently, even when a user changes a display position of the page display region 205 by scrolling the page display region 205, the user can easily recognize the character string region to currently be confirmed.

When the control unit 101 performs enlargement display of a character string region, the enlargement display of which has been once performed by the control unit 101, in the text confirmation mode, the control unit 101 can display this character string region so as to be able to be distinguished from other character string regions. The control unit 101 determines, with reference to the confirmation flag 380 of each character string region, whether each character string region has been enlarged and displayed. If a character string region has been enlarged and displayed, the control unit 101 displays the character string region by indicating that the character string region has been confirmed, so that the character string region is distinguishable from other character string regions. If a character string region has not been enlarged and displayed, the control unit 101 displays the character string region by indicating that the character string region has not been confirmed, so that the character string region is distinguishable from other character string regions. It can be considered that a character string region 903, which has currently be confirmed, is displayed, as illustrated in FIG. 9B, by being surrounded with lines, the type and the color of which are changed from those of lines surrounding other character string regions, or that a mark is displayed in the vicinity of the character string region 903. Consequently, a user can easily recognize a character string region that has been confirmed and a character string region that has been unconfirmed, and can prevent occurrence of confirmation omission and redundant confirmation and can efficiently pursue confirmation work.

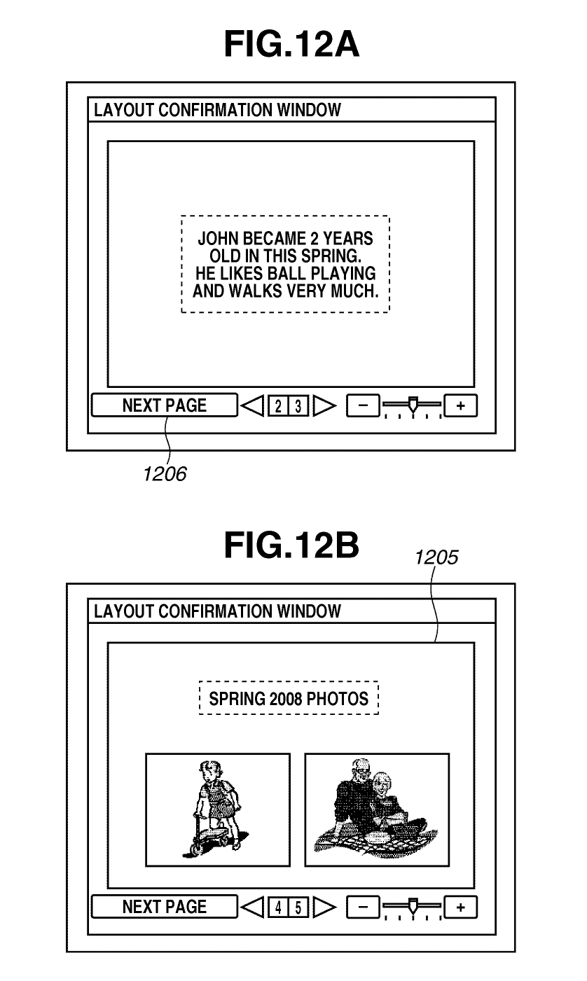

In the above-described exemplary embodiment of the present invention, after the character string region to currently be confirmed reaches the last characteristic string region in a page, when the control unit 101 detects that the text confirmation button 206 is pressed, the control unit 101 returns to the top character string region in the page and performs enlargement display of the character string region. However, the enlargement display according to the present invention is not limited thereto. When the control unit 101 detects that the text confirmation button 206 is pressed after the character string region to currently be confirmed reaches the last characteristic string region in the current page, the control unit 101 can perform control so that the display of the characteristic string region on the current page is changed to the display of the next page, and that then, the enlargement display of the top character string region in the next page is performed. In this case, when the character string region to currently be displayed reaches the last character string region in a page, the control unit 101 sets the expression “NEXT PAGE” on the label of the text confirmation button 1206, instead of the expression “BACK TO THE TOP”, and displays the expression “NEXT PAGE”, as illustrated in FIG. 12A. Then, when the control unit 101 detects that the text confirmation button 206 is pressed, the control unit 101 displays the next facing-pages in the page display region 1205 as illustrated in FIG. 12B. Consequently, a user can sequentially confirm character string regions in the entire document without performing a page turning operation. Accordingly, a user can save a trouble of performing a page turning operation.

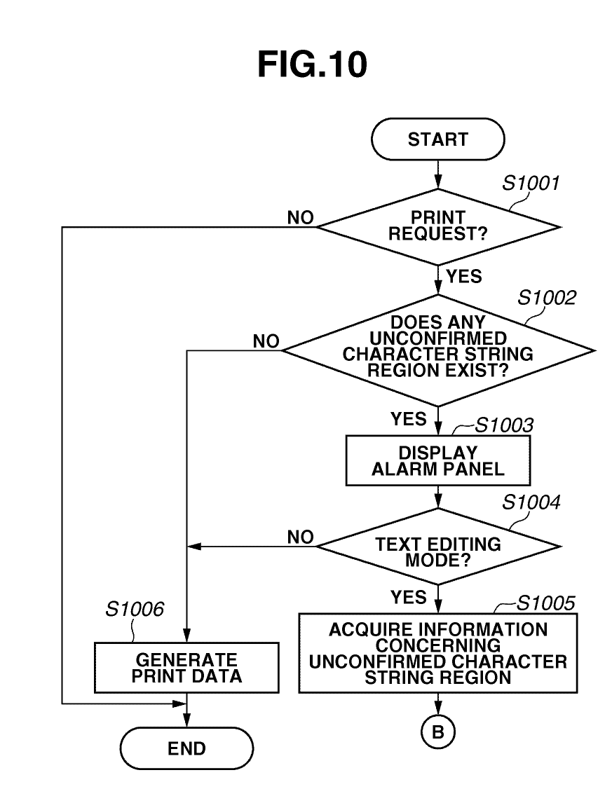

A document generated in the above-described manner is converted into print data in the document editing apparatus 100. Then, the print data is transmitted to a web server apparatus via the Internet. Then, bookbinding and printing are performed on print data using a printer. Hereinafter, an operation by the document editing apparatus 100 for generating print data for requesting the web server to print is described with reference to FIG. 10. The following operation is performed by the control unit 101 of the document editing apparatus 100, which controls various modules.

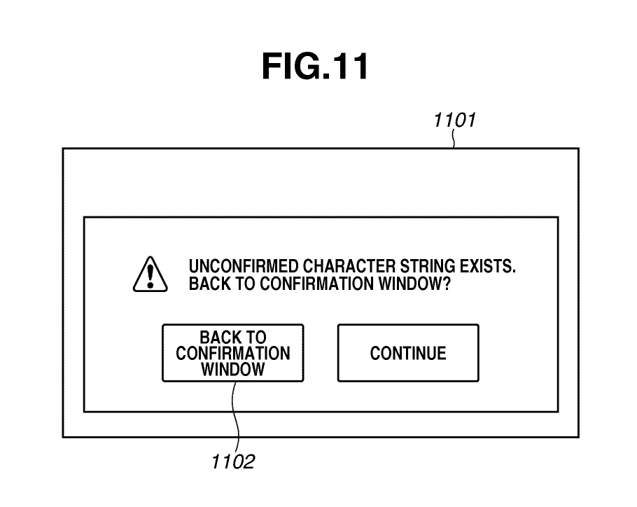

First, in step S1001, the control unit 101 determines whether a print requesting instruction is issued. When the control unit 101 detects, in response to a user's operation, that the operation step “print data generation” 202 is pressed, the control unit 101 determines that a print requesting instruction is issued. If it is determined that a print requesting instruction is issued (YES in step S1001), then in step S1002, the control unit 101 refers to the confirmation flag 380 in each character string region, and searches for a unconfirmed character string region. The control unit 101 can search for character string regions, the number of characters corresponding to each of which is larger than “0”, instead of all character string regions. Consequently, a processing load on the control unit 101 can be reduced. In addition, a user can cut waste of efforts to confirm character string regions into each of which a user cannot erroneously input a character string. If it is determined as a result of search that an unconfirmed character string region is found (YES in step S1002), then in step S1003, the control unit 101 informs a user of the result of search by displaying an alarm panel 1101 illustrated in FIG. 11. In step S1004, the control unit 101 determines whether an instruction to perform transition to the text confirmation mode is issued. When the control unit 101 detects, in response to a user's operation, that the button “BACK TO THE CONFIRMATION WINDOW” 1102 of the alarm panel 1101 is pressed, the control unit 101 determines that an instruction to perform transition to the text confirmation mode is determined. If it is determined that an instruction to perform transition to the text confirmation mode is issued (YES in step S1004), then in step S1005, the control unit 101 acquires a page number 333 of a page in which an unconfirmed character string region exists, a character string ID 338 of the unconfirmed character string, and character string position information 339. Then, processing proceeds to step S602. If it is determined that an instruction to perform transition to the text confirmation mode is not issued (NO in step S1004), or if it is determined that no unconfirmed text string region is found (NO in step S1002), then in step S1006, the control unit 101 generates print data based on various pieces of data managed according to the document management table 310.

In the message area 213, e.g., the expressions “UNCONFIRMED CHARACTER STRING EXISTS IN PAGE.” and “PUSH ‘CONFIRM TEXT’ TO ENLARGE AND CONFIRM CHARACTER STRING” for prompting the text confirmation can be displayed, instead of the alarm panel. In this case, when the control unit 101 detects that the text confirmation button 206 is pressed, then in step S1004, the control unit 101 determines that an instruction to perform transition to the text confirmation mode is issued.

Thus, printing of an erroneous character string can be prevented by checking, when print data is generated, whether no unconfirmed character string region exists.

In the foregoing description, it has been described a case where print data is generated in step S1006 if no instruction to perform transition to the text confirmation mode is issued in step S1004 even when an unconfirmed character string region exists. However, if no instruction to perform transition to the text confirmation mode is issued in step S1004 even when an unconfirmed character string region exists, the control unit 101 can perform control to finish the operation without generating print data. Consequently, an erroneous character string can be more surely prevented from being printed.

In the foregoing description of the present embodiment, the case of performing enlargement display of a character string region laid out on a page has been described. However, similarly, an image region can be enlarged and displayed. Consequently, a user can easily confirm contents of an image, in addition to those of a character string.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-082080 filed Mar. 30, 2009, which is hereby incorporated by reference herein in its entirety.

What is claimed is:

1. A document processing apparatus for displaying, on a screen, a page containing image data and text data arranged to coexist, wherein the page has a text region into which the text data is inserted, the document processing apparatus comprising:
a determination unit configured to determine whether the text data exists in the text region; and
a display unit configured to, in response to a predetermined operation, enlarge and display, on the screen, a range containing the text region in the page if it is determined by the determination unit that the text data exists in the text region.

2. The document processing apparatus according to claim 1, wherein the text region includes a plurality of text regions, and
wherein the display unit sequentially enlarges and displays, on the screen, ranges respectively containing the plurality of text regions.

3. The document processing apparatus according to claim 1, further comprising:
a storage unit configured to store data indicating whether each text region has been enlarged and displayed by the display unit in association with each text region;
a search unit configured to, in response to a predetermined operation, search for a text region, in which the text data exists, that has not been enlarged and displayed by the display unit; and
a notification unit configured to notify a result of search by the search unit.

4. The document processing apparatus according to claim 1, further comprising:
a generation unit configured to generate print data including the image data and the text data in the page;
a storage unit configured to store data indicating whether each text region has been enlarged and displayed by the display unit in association with each text region; and
a search unit configured to, before the generation unit generates the print data, search for a text region, in which the text data exists, that has not been enlarged and displayed by the display unit,
wherein, when, as a result of search by the search unit, a text region, in which the text data exists, that has not been enlarged and displayed by the display unit is found, the generation unit does not generate the print data.

5. A document processing method for displaying, on a screen, a page containing image data and text data arranged to coexist, wherein the page has a text region into which the text data is inserted, the document processing method comprising:
determining whether the text data exists in the text region; and
in response to a predetermined operation, enlarging and displaying, on the screen, a range containing the text region in the page if it is determined that the text data exists in the text region.

6. A computer-readable storage medium storing a program for causing a computer to execute a document processing method for displaying, on a screen, a page containing image data and text data arranged to coexist, wherein the page has a text region into which the text data is inserted, the document processing method comprising:
determining whether the text data exists in the text region; and
in response to a predetermined operation, enlarging and displaying, on the screen, a range containing the text region in the page if it is determined that the text data exists in the text region.
